(19) United States
(12) Patent Application Publication
(10) Pub. No.: US 2007/0057236 A1
(43) Pub. Date: Mar. 15, 2007

(54) Conductive resin composition and the use thereof

(75) Inventors: Tomoya Hosoda, Tsukuba-shi (JP); Satoshi Okamoto, Tsukuba-shi (JP); Mitsuo Maeda, Tsukuba-shi (JP)

Correspondence Address: FOLEY AND LARDNER LLP;SUITE 500, 3000 K STREET NW, WASHINGTON, DC, 20007, US

(73) Assignee: SUMITOMO CHEMICAL COMPANY, LIMITED

(21) Appl. No.: 11/483,673

(22) Filed: Jul. 11, 2006

(30) Foreign Application Priority Data
Sep. 12, 2005 (JP) 2005-263459

(51) Int. Cl. H01B 1/12

(52) U.S. Cl. 252/500

(57) ABSTRACT

The present invention provides a conductive resin composition comprising a liquid crystalline polyester which comprises the following structure units having the formulas (i), (ii) and (iii), and has an aromatic group having 2,6-naphthalenediyl group in a ratio of not less than 5% by mole; and at least one filler selected from a metal oxide conductive filler and a carbon conductive filler. According to the present invention, the composition is easy to mold and can give molded products having high hydrolysis resistance. The resulting molded products are hardly to lower the strength even if they are exposed to high temperature and humid condition, and can be suitably used for a separator in a fuel cell.

### BACKGROUND OF THE INVENTION

1. Field of the Invention

The present invention relates to a conductive resin composition, and a separator useful in a fuel cell and a sealing material, both of which are made from the conductive resin composition.

2. Related Background Art

Recently, a solid-polymer-type fuel cell has been developed toward practical uses of portable uses, uses for vehicles and stationary uses. The solid-polymer-type fuel cell may comprise solid polymer electrolyte film, catalytic membrane, gas diffusion membrane and separator. Among them, the separator is required to have good moldability (such as easiness in mold processing) as well as long-term stability.

For example, the separator in the fuel cell may be required to have stability in a long-term operation and stability at high temperature under humid condition, because the separator tends to be exposed to such a condition, which is caused by heat and water (as a by-product around cathodes) generated in the fuel cell while driving.

It is known that aresin composition is useful for producing a separator because of its good moldability. For example, a conductive resin composition of a liquid crystalline polyester and a conductive filler is known. However, such a conventional resin composition is insufficient in long-term stability, especially in hydrolysis resistance.

### SUMMARY OF THE INVENTION

Under such a circumstance, the present invention has been made to provide a conductive resin composition which is not only easy to mold but also gives a molded product having high hydrolysis resistance, and to provide a separator and a sealing material comprising the conductive resin composition, which can be suitably used for fuel cells.

As a result of repeated studies by the present inventors, a liquid crystalline polyester having high hydrolysis resistance have been found, and it has been found that a conductive resin composition comprising the liquid crystalline polyester can solve the above-mentioned issues; and the present invention has been accomplished.

The present invention provides a conductive resin composition comprising:

a liquid crystalline polyester which comprises the following structure units having the formulas (i), (ii) and (iii), and has an aromatic group having 2,6-naphthalenediyl group in a ratio of not less than 5% by mole based on 100% by mole of the total of divalent aromatic groups Ar₁, Ar₂ and Ar3; 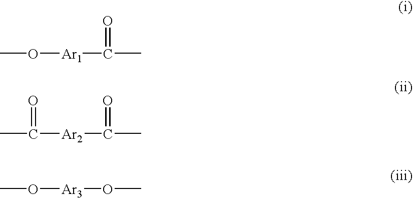
wherein Ar₁ is selected from 2,6-naphthalenediyl group, 1,4-phenylene group and 4,4′-biphenylylene group, Ar₂ and Ar₃ are each independently selected from2,6-naphthalenediyl group, 1,4-phenylene group, 1,3-phenylylene group and 4,4′-biphenylylene group, provided that at least one of Ar₁, Ar₂ and Ar₃ is 2,6-naphthalenediyl group; and the groups Ar₁, Ar₂ and Ar₃ optionally have a halogen atom, an alkyl group having 1 to 10 carbon atoms or an aryl group; and

at least one filler selected from a metal oxide conductive filler and a carbon conductive filler.

Further, the present invention provides a fuel cell separator and a sealing material for a fuel cell, which each comprise the above-mentioned conductive resin composition.

In particular, the fuel cell separator comprising the conductive resin composition of the present invention is superior in long-term stability in fuel cell operation.

According to the present invention, the composition not only is easy to mold but also can give molded products having higher hydrolysis resistance than that of molded products obtained from conductive resin compositions comprising a conventional liquid crystalline polyester. The thus obtained molded products are hardly to lower the strength even if they are exposed to high temperature and humidity conditions, and can be suitably used for a separator, a sealing material and the like in a fuel cell.

### DETAILED DESCRIPTION OF THE PREFERRED EMBODIMENT

The present invention provides a conductive resin composition comprising a liquid crystalline polyester and at least one filler selected from a metal oxide conductive filler and a carbon conductive filler.

Liquid Crystalline Polyester

The liquid crystalline polyester used in the present invention comprises the following structure units having the formulas (i), (ii) and (iii), and has an aromatic group having 2,6-naphthalenediyl group in a ratio of not less than 5% by mole based on 100% by mole of the total of divalent aromatic groups Ar₁, Ar₂ and Ar₃; 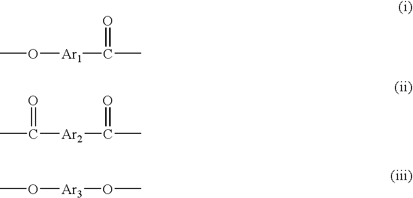
wherein Ar₁ is selected from 2,6-naphthalenediyl group, 1,4-phenylene group and 4,4′-biphenylylene group, Ar₂ and Ar₃ are each independently selected from 2,6-naphthalenediylgroup, 1,4-phenylene group, 1,3-phenylylene group and 4,4′-biphenylylene group, provided that at least one of Ar₁, Ar₂ and Ar₃ is 2,6-naphthalenediyl group; and the groups Ar₁, Ar₂ and Ar₃ optionally have a halogen atom, an alkyl group having 1 to 10 carbon atoms or an aryl group.

Here, the liquid crystalline polyester is referred to a polyester showing optical anisotropy upon melting at a temperature of not more than 450° C. Such a liquid crystalline polyester can be obtained by selecting law material monomers, namely monomers having 2,6-naphthalenediyl group and other is monomers having an aromatic ring so that the obtained polyester has the structure units having 2,6-naphthalenediyl group in a ratio of not less than 5% by mole; and polymerizing the monomer, in the production step of the liquid crystalline polyester.

In the conductive resin composition of the invention, the liquid crystalline polyester has the aromatic groups having 2,6-naphthalenediyl group in a ratio of, not less than 5% by mole (as mentioned above), preferably not less than20% by mole, more preferably not less than 25% by mole, and most preferably not less than 50% by mole, based on 100% by mole of the total 5 of the divalent aromatic groups Ar₁, Ar₂ and Ar₃. Such liquid crystalline polyesters is preferable because of more excellent hydrolysis resistance.

It is preferable that the total ratio of the structure units (i) (which is derived from an aromatic hydroxycarboxylic 10 acid) is 30 to 80% by mole, the total ratio of the structure units (ii) (which is derived from an aromatic dicarboxylic acid) is 10 to 35% by mole and the total ratio of the structure units (iii) (which is derived from an aromatic diol) is 10 to 35% by mole, based on 100% by mole of the total of the structure units (i), (ii) and (iii).

The liquid crystalline polyester of the invention is preferably whole-aromatic polyester, since the resulting composition has also high heat resistance due to the high heat resistance of the polyester. The term “whole-aromatic polyester” as used herein refers to a polyester wherein the divalent aromatic groups Ar₁, Ar₂ and Ar₃ are bonded to one another through an ester bond (—C(O)O—), and the ratio of the structure units (ii) and the ratio of the structure units (iii) in all of the structure units forming the resin are substantially equal.

Although not outside the scope of the present invention, when the ratio of the structure units derived from the aromatic hydroxycarboxylic acid is less than 30% by mole, or the structure units derived from the aromatic dicarboxylic acid or the structure units derived from the aromatic diol is more than 35% by mole, the obtained resin tends to hardly show liquid crystallinity.

Also again while not outside the scope of the present invention, when the ratio of the structure units derived from the aromatic hydroxycarboxylic acid is more than 80% by mole, or the structure units derived from the aromatic dicarboxylic acid or the structure units derived from the aromatic diol is less than 10% by mole, the obtained liquid crystalline polyester may be hard to melt, thus sometimes resulting in lowering processability.

The ratio of the structure units derived from the aromatic hydroxycarboxylic acid is more preferably 40 to 70% by mole, especially preferably 45 to 65% by mole.

On the other hand, the ratio of the structure units derived from the aromatic dicarboxylic acid and the structure units derived from the aromatic diol are each more preferably 15 to 30% by mole, especially preferably 17.5 to 27.5% by mole.

Examples of the monomer forming the structure unit (i) include 2-hydroxy-6-naphthoic acid, p-hydroxybenzoic acid and 4-(4-hydroxyphenyl)benzoic acid, as well as these monomers wherein hydrogen atom of the benzene ring or the naphthalene ring is substituted by a halogen atom, an alkyl group having 1 to 10 carbon atoms or an aryl group. Here, the monomer forming the structure unit having 2,6-naphthalenediyl group of the invention includes 2-hydroxy-6-naphthoic acid and the 2-hydroxy-6-naphthoic acid wherein hydrogen atom of the naphthalene ring may be substituted by the above-mentioned group (including halogen atom). Ester-forming derivatives thereof, mentioned below, may also be used.

Examples of the monomer forming the structure unit (ii) include naphthalene-2,6-dicarboxylic acid, terephthalic acid, isophthalic acid and biphenyl-4,4′-dicarboxylic acid, as well as these monomers wherein hydrogen atom of the naphthalene ring is substituted by a halogen atom, an alkyl group having 1 to 10 carbon atoms or an aryl group. Here, the monomer forming the structure unit having 2,6-naphthalenediyl group of the invention includes naphthalene-2,6-dicarboxylic acid, and the naphthalene-2,6-dicarboxylic acid wherein hydrogen atom of the naphthalene ring may be substituted by the above-mentioned group(including halogen atom). Ester-forming derivatives thereof, mentioned below, may also be used.

Examples of the monomer forming the structure unit (iii) include 2,6-naphthol, hydroquinone, resorcin and 4,4′-dihydroxybiphenyl, as well as these monomers wherein hydrogen atom of the naphthalene ring is substituted by a halogen atom, an alkyl group having 1 to 10 carbon atoms or an aryl group. Here, the monomer forming the structure unit having 2,6-naphthalenediyl group of the invention includes 2,6-naphthol and the 2,6-naphthol wherein hydrogen atom of the naphthalene ring may be substituted by the above-mentioned group(including halogen atom). Ester-forming derivatives thereof, mentioned below, may also be used.

As mentioned above, the structure units (i), (ii) and (iii) may have a substituent in its aromatic rings (benzene ring and naphthalene ring). Examples of the substituent include halogen atoms such as fluorine atom, chlorine atom, bromine atom, and iodine atom; alkyl groups having 1 to 10 carbon atoms represented by methyl group, ethyl group, propyl group, butyl group, hexyl group, octyl group, decyl group, and the like, which may be linear or branced, or alicyclic groups; aryl groups represented by phenyl group, naphthyl group, and the like, which have 6 to 20 carbon atoms.

In order to easily conduct the polymerization of the monomers forming structure units (i), (ii) and (iii), it is preferable that ester-forming derivatives thereof are used in the course of the polyester production. The ester-forming derivative refers to a monomer having a group capable of promoting ester-forming reaction, and specifically includes highly reactive derivatives such as ester-forming derivatives wherein carboxyl group in the monomer molecule is converted into an acid halide or an acid anhydride; and ester-forming derivatives wherein hydroxyl group in the monomer molecule is converted into a lower carboxylic acid ester group.

The liquid crystalline polyester can be produced in known methods, and, it is particularly preferable to use, as the ester-forming derivative, the derivatives wherein hydroxyl group in the monomer is converted into a lower carboxylic acid ester group. Acyl group is particularly preferable as the lower carboxyl group. Acylation can usually be conducted by reacting a monomer having hydroxyl group with acetic anhydride. These ester-forming derivatives obtained by the acylation can be polymerized by polycondensation while removing acetic acid to easily produce polyesters.

For example, a method described in Japanese Patent Application Laid-open Publication No. 2002-146003 is applicable to provide the liquid crystalline polyester. Namely, the monomers corresponding to the structure units (i), (ii) and (iii) are selected so as to be a monomer ratio of the structure units having 2,6-naphthalenediyl group of not less than 5% by mole in the total monomers; the selected monomers are, if necessary, converted into ester-forming derivatives; the monomers are subjected to melt-polycondensation to give an aromatic liquid crystalline polyester having a relatively low molecular weight (hereinafter abbreviated to as “prepolymer”); the prepolymer is formed into a power; the powder is subjected to solid phase polymerization with heat to give a desired polyester. The use of the solid phase polymerization can give polyesters having a higher molecular weight, because the polymerization can further proceed.

Conductive Filler

As mentioned above, a conductive resin composition in the present invention provides comprises at least one filler selected from a metal oxide conductive filler and a carbon conductive filler. The metal oxide conductive filler and the carbon conductive filler may be the conductive fillers which have been known. Examples of the metal oxide conductive filler include SnO₂, ZnO, In₂O ₃, TiO₂, and the like. Examples of the carbon conductive filler include so-called carbon black which may be obtained by controlling heat decomposition and imperfect combustion of hydrocarbon; carbon allotropes having conductivity such as graphite; and complexes of carbon black and graphite. The shape of the metal oxide conductive filler and carbon conductive filler is not particular limited, and any shapes such as a powder, fiber and flake can be used so long as the fillers can be dispersed in or admixed with the liquid crystalline polyester. Further, combinations of the metal oxide conductive filler and the carbon conductive filler may be used.

The carbon conductive filler is particularly preferably used in the conductive resin composition of the present invention, and the carbon powder, carbon flake, carbon black, graphite and/or the like are preferably used. When such a carbon filler is utilized in the in the conductive resin composition, the corrosion resistance of the conductive resin compositions ca be improved to prevent molds from deterioration during the molding process. Also, when the conductive resin composition having such a carbon filler is utilized for a fuel-cell separator or the like, side reactions can be prevented. It is more preferred to utilize at least one filler selected from the group consisting of graphite, Ketjen black, acetylene black, furnace carbon black and thermal carbon black. By using them, the resulting composition has much higher conductivity.

The carbon conductive filler may be used alone or in combination of 2 or more kind of them. It is more preferred to utilize graphite or Ketjen black, particularly preferably graphite. Among the carbon conductive filler, the graphite is preferable because it has few hydrophilic groups such as quinone group and carboxyl group. The types of the graphite are not particularly limited, and any types such as granular graphite, flake graphite, expanded graphite and colloidal graphite may be used. Further, graphite intercalation compounds wherein fluorinated graphite, and various metal atoms, halogen atoms or halogen compounds are intercalated may be used. Here, the term “expanded graphite” refers to graphite wherein the spaces between layers in the crystal structure are expanded, which has particularly high conductivity and lubricity. Among the graphite, the expanded graphite and the granular graphite are particularly preferable because the use of them further improves the conductivity.

The amount of the metal oxide conductive filler and/or carbon conductive filler to be added is preferably 50 to 900 parts by weight based on 100 parts by weight of the liquid crystalline polyester. Although not outside the scope of the present invention, when the amount of the conductive filler to be added is less than 50 parts by weight, it may be difficult to attain satisfactory conductivity. Also again while not outside the scope of the present invention, when the amount is more than 900 parts by weight, moldability of the resulting composition and strength of the resulting molded product tend to be lowered. Taking these points into account, the amount of the conductive filler to be added is more preferably 100 to 600 parts by weight, particularly preferably 200 to 500 parts by weight.

Other Additives

The conductive resin composition of the present invention may further comprise fibers such as carbon fibers, resin fibers or glass fibers to provide a molded product (for example, fuel cell separators and sealing materials) having much stronger mechanical strength. For example, when the conductive resin composition contains carbon fiber and/or the glass fiber in the amount of about 1 to 100 parts by weight, particularly about 10 to 50 parts by weight, based on 100 parts by weight of the liquid crystalline polyester, the resulting molded products can have improved strength, particularly improved impact resistance. The types of the carbon fiber, resin fiber and glass fiber are not particularly limited, and various known fibers may be used.

In addition thereto, the conductive resin composition of the present invention may further comprise other fibers such as cotton, wool, silk, hemp, nylon fiber, aramid fiber, vinylon (polyvinyl alcohol) fiber, polyester fiber, rayon fiber, acetate fiber, phenol-formaldehyde fiber, polyphenylene sulfide fiber, acrylic fiber, polyvinyl chloride fiber, polyvinylidene chloride fiber, polyurethane fiber and tetrafluoroethylene fiber.

In the present invention, the carbon fiber, in particular PAN carbon fiber or pitch carbon fiber is preferably used. The use of such a carbon fiber can improve the strength of molded products without impairing the conductivity of the molded products. The shape of the fiber is not particularly limited, and fiber having a length within the range of about 0.01 to 100 mm, particularly about 0.1 to 20 mm is preferably used. When the fiber with length of more than 100 mm is utilized, it may become difficult to mold the resulting composition and it may be difficult to obtain a molded product with a smooth surface. On the other hand, when the fiber with length of less than 0.01 mm, it may be difficult to a molded product with improved strength.

In addition to the above-mentioned additives, the conductive resin composition of the invention may contain optional components such as other polymers, e.g., polyethylene terephthalate (PET), polybutylene terephthalate (PBT), thermoplastic polyester elastomers, polyesters with a low molecular weight, polyamide, nitrile rubber, and acrylic rubber; other fillers and pigments, e.g., silica, calcium carbonate, barium sulfate, and viscose mineral; dispersing agents, anti-oxidants, coupling agents, compatibilizers, flame retardants, surface lubricants, fatty acids and their esters, plasticizer such as phthalic acid esters, plastic powders, processing aids within the range where the conductivity is not lowered.

In addition to the metal oxide conductive filler and/or carbon conductive filler, metal fillers may be added within the range where water absorbing property of the molded products obtained from the conductive resin composition of the invention is not impaired.

Preparation of the Conductive Composition

The conductive resin composition of the invention may be produced in various common manners. In general, the liquid crystalline polyester is melted with heat and kneaded, and the conductive fillers and fibers are added thereto. The liquid crystalline polyester is typically melted on a kneader, Banbury mixer, extruder, or heat roller, to which the conductive fillers and fibers are added while kneading them.

The conductive resin composition of the invention is easy to mold and has high hydrolysis resistance. It is therefore optimum for materials of fuel cell separators. The conductive resin composition of the invention using the carbon filler, especially graphite, as the conductive filler, can provide a molded product having high gas impermeability, good sliding property and surface conformability. It is therefore optimum for sealing materials, especially packing materials used in the production of fuel cells.

Method for Molding the Conductive Composition

The methods for molding the conductive resin composition of the present invention are not particularly limited. The conductive resin composition may be formed into various shapes by using various general molding methods used in the thermoplastic resin field, such as injection molding, extrusion molding, transfer molding, blow molding, press molding, injection-press molding and injection-extrusion molding. The molding methods may also be used in combination of two or more of them. When the fuel cell separator of the invention is produced, it is preferred to employ the injection molding, the press molding or the injection-press molding. For example, the obtained molded product may be melt-bonded to each other by the injection molding or extrusion molding. Also, a sheet obtained by the extrusion molding or press molding may be molded again into an article with complicated uneven surface by the press molding or the like. An optimal forming method and conditions depending on the use and shape can be selected. Since the conductive resin composition is capable of melt-molding, it is particularly useful for materials of articles with a complicated shape, thick articles which are hardly heated and the like. Furthermore, recycle of the molded product and reuse of burr portions can be conducted.

The invention being thus described, it will be apparent is that the same may be varied in many ways. Such variations are to be regarded as within the spirit and scope of the invention, and all such modifications as would be apparent to one skilled in the art are intended to be within the scope of the following claims.

The entire disclosure of the Japanese Patent Application No. 2005-263459 filed on Sep. 12, 2005 including specification, claims and summary, are incorporated herein by reference in their entirety.

### EXAMPLES

The present invention is described in more detail by following Examples, which should not be construed as a limitation upon the scope of the present invention.

Measurement of Flow Starting Temperature

About 2 g of a sample was filled in a capillary rheometer provided with a dice (inner diameter: 1 mm, length: 10 mm) using a flow tester (“CFT-500 type” made by Shimadzu Corporation). The aromatic polyester was extruded from the nozzle at a rate of temperature rise of 4° C./minute under a load of 9.8 MPa (100 kg/cm²), and a temperature was measured at the time when the melt viscosity reached 4,800 Pa.s (48,000 poises) as a flow starting temperature.

### Synthesis Example 1

To a reactor equipped with a stirrer, a torque meter, a nitrogen gas-introducing tube, a thermometer, and a reflux condenser were added 987.95 g (5.25 moles) of 2-hydroxy-6-naphthoic acid, 486.47 g (2.612 moles) of 4,4′-dihydroxybiphenyl, 513.45 g (2.375 moles) of 2,6-naphthalenedicarboxylic acid, 1174.04 g (11.5 moles) of acetic anhydride and 0.194 g of 1-methyl imidazole as a catalyst, and the mixture was stirred at room temperature for 15 minutes, and then the temperature was elevated while the mixture was stirred. The mixture was stirred at 145° C. for further 1 hour after the inner temperature reached 145° C., to which the catalyst, 5.83 g of 1-methyl imidazole was added.

Then, while the by-product acetic acid and unreacted acetic anhydride were distilled away, the temperature was elevated from 145° C. to 310° C. over 3 and half hours. The reaction mixture was kept at 310° C. for 2 hours to give a liquid crystalline polyester. The obtained liquid crystalline polyester was cooled down to room temperature, pulverized on a pulverizer to give a liquid crystalline polyester powder (particle size: about 0.1 mm to about 1 mm).

A flow starting temperature of the obtained powder (the liquid crystalline polyester) was measured using the flow tester, and it was found to be 273° C.

The temperature of the obtained powder was elevated from is 25° C. to 250° C. over 1 hour, then from the 250° C. to 300° C. over 10 hours, and it was kept at 300° C. over 12 hours to conduct solid phase polymerization. The resulting powder was cooled down to give a liquid crystalline polyester, which is referred to as A. A flow starting temperature of the polyester A was measured using the flow tester, and it was found to be 326° C.

### Synthesis Example 2

To the same reactor as used in Synthesis Example 1 were added 1034.99 g (5.5 moles) of 2-hydroxy-6-naphthoicacid, 272.52 g (2.475 moles) of hydroquinone, 378.33 g (1.75 moles) of 2,6-naphthalenedicarboxylic acid, 83.07 g (0.5 mole) of terephthalic acid, 1226.87 g (11.9 moles) of acetic anhydride and 0.17 g of 1-methyl imidazole as a catalyst, the mixture was stirred at room temperature for 15 minutes, and then the temperature was elevated while the mixture was stirred. The mixture was stirred at 145° C. for further 1 hour after the inner temperature reached 145° C.

Then, while the by-product acetic acid and unreacted acetic anhydride were distilled away, the temperature was elevated from 145° C. to 310° C. over 3 and half hours. The reaction mixture was kept at 310° C. for 3 hours to give a liquid crystalline polyester. The obtained liquid crystalline polyester was cooled down to room temperature, pulverized on a pulverizer to give a liquid crystalline polyester powder (particle size: about 0.1 mm to about 1 mm).

A flow starting temperature of the obtained powder (the liquid crystalline polyester) was measured using the flow tester, and it was found to be 261° C.

The temperature of the obtained powder was elevated from 25° C. to 250° C. over 1 hour, then from the 250° C. to 295° C. over 8 hours, and it was kept at 295° C. over 3 hours to conduct solid phase polymerization. The resulting powder was cooled down to give a liquid crystalline polyester, which is referred to as B. A flow starting temperature of the polyester B was measured using the flow tester, and it was found to be 310° C.

### Synthesis Example 3

To the same reactor as used in Synthesis Example 1 were added 828.72 g (6.00 moles) of parahydroxybenzoic acid, 330.33 g (3.00 moles) of hydroquinone, 648.57 g (3.00 moles) of 2,6-naphthalenedicarboxylic acid, 1408.84 g (13.8 moles) of acetic anhydride and 0.181 g of 1-methyl imidazole as the catalyst, the mixture was stirred at room temperature for 15 minutes, and then the temperature was elevated while the mixture was stirred. The mixture was stirred at 145° C. for further 30 minutes after the inner temperature reached 145° C.

Then, while the by-product acetic acid and unreacted acetic anhydride were distilled away, the temperature was elevated from 145° C. to 310° C. over 3 hours, to which 1.808 g of 1-methyl imidazole was added. The reaction mixture was kept at 310° C. for 1 hour to give a liquid crystalline polyester. The obtained liquid crystalline polyester was cooled down to room temperature, pulverized on a pulverizer to give a liquid crystalline polyester powder (particle size: about 0.1 mm to about 1 mm).

The temperature of the obtained powder was elevated from 25° C. to 250° C. over 1 hour, then from the 250° C. to 304° C. over 10 hours, and it was kept at 304° C. over 4 hours to conduct solid phase polymerization. The resulting powder was cooled down to give a liquid crystalline polyester, which is referred to as C. A flow starting temperature of the polyester C was measured using the flow tester, and it was found to be 324° C.

### Synthesis Example 4

To the same reactor as used in Synthesis Example 1 were added 911 g (6.6 moles) of p-hydroxybenzoic acid, 409 g (2.2 moles) of 4,4′-dihydroxybiphenyl, acid 91 g (0.55 mole) of isophthalic and 274 g (1.65 moles) of terephthalic acid in place of 2,6-naphthalenedicarboxylic acid, and 1235 g (12.1 moles) of acetic anhydride, and 1-methyl imidazole was not used, and the stirring at room temperature, elevating the temperature and keeping the temperature were conducted in the same manner as in Synthesis Example 1.

Then, while the by-product acetic acid and unreacted acetic anhydride were distilled away, the temperature was elevated and the reaction mixture was kept at the temperature for 1 hour in the same manner as in Synthesis Example 1 except that 1-methyl imidazole was not added to give a prepolymer.

Then the procedure of Synthesis Example 1 was repeated to give a prepolymer powder (particle size: about 0.1 mm to about 1 mm). A flow starting temperature of the prepolymer was 255° C.

The temperature of the obtained powder was elevated from 25° C. to 250° C. over 1 hour, then from the 250° C. to 285° C. over 5 hours, and it was kept at 285° C. over 3 hours to conduct solid phase polymerization. The resulting powder was cooled down to give a liquid crystalline polyester, which is referred to as D. A flow starting temperature of the polyester D was measured using the flow tester, and it was found to be 324° C.

### Examples 1 to 3 and Comparative Example 1

The liquid crystalline polyester obtained in each Synthesis Example 1 to 4, and graphite (“SP-5” made by Nippon Graphite Industries Co., Ltd.) were dry-blended in the following manner.

Using a twin screw extruder (“PCM30-HS” made by Ikegai Corporation), F30, L/D=45), the liquid crystalline polyester was supplied from a first feeder and the graphite was supplied from a side feeder, and the mixture was kneaded in a mixing ratio (weight ratio) and conditions shown in Table 1 to prepare pellets. The obtained pellets were molded with an injection molding machine (“PS40E%ASE” made byNissei Plastic Industrial Co., Ltd.) to give test pieces.

The obtained test pieces were subjected to the following hydrolysis resistance test, and examined degrees of deterioration of the test pieces under a high temperature and humidity condition.

Hydrolysis Resistance Test

Ten test pieces (JIS K 71131(1/2) dumbbell×1.2 mmt) were manufactured from the pellets obtained in each Example at molding temperatures shown in Table 1. As to five test pieces among the ten, the tensile strength was measured (the initial strength). The remaining five test pieces were put in a high acceleration life tester (made by TABAI), and were kept to stand for 200 hours under high temperature and humidity conditions such as a temperature of 121° C. and a humidity of 100%, and then were taken out of the tester (the exposure test at a high temperature and humidity). As to the five test pieces subjected to the exposure 5 test at a high temperature and humidity, tensile strengths were measured, and calculated a retention (%) of the tensile strength after the exposure test to the initial strength.

Tensile strength retention (%) =(an average value of the strengths of the five test pieces obtained 10 after the exposure test at a high temperature and humidity)/ (an average value of the initial strengths of the five test pieces) ×100

TABLE 1

| | Example | Example | Example | Comparative |
|---|---|---|---|---|
| | 1 | 2 | 3 | Example 1 |
| Kind of liquid | A | B | C | D |
| crystalline | | | | |
| polyester | | | | |
| Ratio of 2,6- | 74% by | 71% by | 25% by | 0% by |
| naphthalenediyl | mole | mole | mole | mole |
| groups in all | | | | |
| aromatic groups | | | | |
| forming the liquid | | | | |
| crystalline polyester | | | | |
| Liquid crystalline | 100 | 100 | 100 | 100 |
| polyester (part by | | | | |
| weight) | | | | |
| Graphite | 200 | 200 | 200 | 200 |
| (part by weight) | | | | |
| Granulating | 350 | 340 | 350 | 350 |
| temperature | | | | |
| (° C.) | | | | |
| Molding | 360 | 350 | 360 | 360 |
| temperature | | | | |
| (° C.) | | | | |
| Tensile strength | 85 | 84 | 80 | 56 |
| retention (%) | | | | |

The molded test pieces using the conductive resin compositions of the invention, obtained in Examples 1 to 3, had tensile strength retentions of not less than 80% to the initial stage even after they were exposed to the high temperature and high humidity. On the other hand, the test pieces obtained in Comparative Example 1, which were an example of molded products obtained from the conductive resin compositions using a conventional liquid crystalline polyester, had remarkably lowered mechanical strength, which was caused by the same conditions of high temperature and humidity as above.

Further, it was proved that the higher the ratio of 2,6-naphthalenediyl groups in the structure units of the liquid crystalline polyester, the higher the tensile strength retention, thus resulting in higher hydrolysis resistance.

What is claimed is:

1. The present invention provides a conductive resin composition comprising:
a liquid crystalline polyester which comprises the following structure units having the formulas (i), (ii) and (iii), and has an aromatic group having 2,6-naphthalenediyl group in a ratio of not less than 5% by mole based on 100% by mole of the total of divalent aromatic groups Ar₁, Ar₂ and Ar₃; 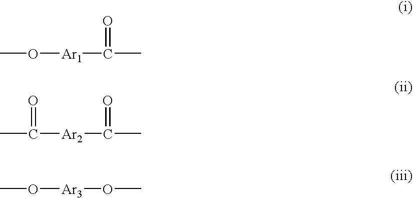
wherein Ar₁ is selected from 2,6-naphthalenediyl group, 1,4-phenylene group and 4,4′-biphenylylene group, Ar₂ and Ar₃ are each independently selected from 2,6-naphthalenediyl group, 1,4-phenylene group, 1,3-phenylylene group and 4,4′-biphenylylene group, provided that at least one of Ar₁, is Ar₂ and Ar₃ is 2,6-naphthalenediyl group; and the groups Ar₁, Ar₂ and Ar₃ optionally have a halogen atom, an alkyl group having 1 to 10 carbon atoms or an aryl group; and
at least one filler selected from a metal oxide conductive filler and a carbon conductive filler.

2. The conductive resin composition according to claim 1, wherein the liquid crystalline polyester has the aromatic group having 2,6-naphthalenediyl group in a ratio of not less than 20% by mole based on 100% by mole of the total of divalent aromatic groups Ar₁, Ar₂ and Ar₃.

3. The conductive resin composition according to claim 2, wherein the liquid crystalline polyester has the aromatic group having 2,6-naphthalenediyl group in a ratio of not less than 50% by mole based on 100% by mole of the total of divalent aromatic groups Ar₁, Ar₂ and Ar₃.

4. The conductive resin composition of according to claim 1, which comprises the carbon conductive filler as an essential component.

5. The conductive resin composition according to claim 4, wherein the carbon conductive filler is at least one conductive filler selected from the group consisting of graphite, Ketjen black, acetylene black, furnace carbon black and thermal carbon black.

6. The conductive resin composition according to claim 4, wherein the carbon conductive filler is graphite.

7. The conductive resin composition according to claim 1, wherein at least one filler selected from the metal oxide conductive filler and the carbon conductive filler is contained in an amount of 50 to 900 parts by weight based on 100 parts by weight of the liquid crystalline polyester.

8. The conductive resin composition according to claim 1, wherein at least one filler selected from the metal oxide conductive filler and the carbon conductive filler is contained in an amount of 100 to 600 parts by weight based on 100 parts by weight of the liquid crystalline polyester.

9. A separator for fuel cell, which is made from the conductive resin composition according to claim 1.
